(19) United States
(12) Patent Application Publication
(10) Pub. No.: US 2022/0195347 A1
(43) Pub. Date: Jun. 23, 2022

(54) COMPOSITION

(71) Applicant: Reckitt Benckiser Vanish B.V., Hoofddorp (NL)

(72) Inventors: Manola GIANOLLA, Mira (IT); Federico PACINI, Mira (IT); Dora ZAMUNER, Mira (IT)

(73) Assignee: Reckitt Benckiser Vanish B.V, Hoofddorp (NL)

(21) Appl. No.: 17/258,033

(22) PCT Filed: Jul. 5, 2019
(86) PCT No.: PCT/EP2019/068152

§ 371 Date: Jan. 5, 2021

(30) Foreign Application Priority Data
Jul. 6, 2018 (GB) 1811100.5

(51) Int. Cl. C11D 3/38; C11D 3/39; C11D 11/00; C11D 17/00

(52) U.S. Cl. CPC C11D 3/381; C11D 3/39; C11D 17/0008; C11D 11/0029; C11D 11/0035; C11D 11/0017

(57) ABSTRACT

A composition for use in stain removal comprising at least one probiotic, bleach, and an enrichment medium.

### FIELD OF THE INVENTION

The present invention relates to compositions for use in stain removal. The compositions include at least one probiotic, bleach, and an enrichment medium. The enrichment medium acts to maintain the viability of the probiotic in the presence of the bleach thereby resulting in a composition that is stable and has prolonged shelf life. The present invention also relates to methods for producing the compositions for stain removal, and uses of the compositions for stain removal.

### BACKGROUND TO THE INVENTION

Cleaning products are typically required to tackle a large number of different types of stains. Stains may be characterised as protein-based stains, oil-based stains, tannin-based stains, or dye-based stains, for example. Stains may also be described as enzymatic, oxidisable, greasy, or particulate, and importantly, a stain may comprise a combination of these different elements. Due to the different characteristics of each type of stain, different methods are often employed in order to remove a complex stain. Consequently, different cleaning products are required to contain different active agents to tackle the different components of stains.

Bleach can be used to tackle oxidisable stains, also known as bleachable stains, such as coffee and red wine. Alternatively, enzymes can be used to tackle enzymatic stains, such as blood and grass. Probiotics can be used as a source of enzymes capable of digesting and degrading soils. Examples of probiotic-containing cleaning products are described in WO2012/042220. US2011/0207649 describes antimicrobial cleaning compositions that include bacterial or fungal spores which produce enzymes to aid in the degradations of soils. The compositions further include a borate salt to maintain an alkaline pH and prevent the loss of viable spores.

### SUMMARY OF INVENTION

It has typically not been possible to combine bleach and probiotics or enzymes in the same cleaning product. Bacteria and the associated enzymes used in cleaning products are not usually stable in the oxidising conditions present in a bleach-based product; these conditions will kill bacteria and inactivate the enzymes. Consequently, cleaning products in liquid form that contain bleach typically do not contain probiotics or enzymes. Instead the bleach and the enzymes must be provided separately. To tackle this problem, special storage techniques have been employed, such as dual chamber bottles which keep the enzymes separate from the bleach when stored, for example as described in US2010/0286017. The two components only come into contact when mixed together immediately prior to stain removal. Typically, an enzyme in a bleaching environment will only remain active for 15 to 20 minutes, which may be long enough to tackle a stain, or run a short wash cycle, but is not sufficient for a cleaning product that will stay on a shelf for several days, or months.

The invention provides a cleaning product that contains both bleach and bacterial enzymes and is stable such that it can be stored for a prolonged period.

The present inventors have identified that inclusion of an enrichment medium in a composition comprising both bleach and a probiotic prevents the loss of viable bacterial spores and stabilises the composition. The enrichment medium is typically a chemically-defined broth that contains the necessary ingredients to maintain a viable probiotic culture in the presence of bleach.

In a first aspect, the present invention provides a composition for use in stain removal comprising at least one probiotic, bleach, and an enrichment medium. In preferred embodiments, the composition comprises (i) at least one probiotic selected from Bacillus megaterium, Bacillus amyloliquefaciens, Bacillus subtilis, and Bacillus pumilus; (ii) hydrogen peroxide bleach; and (iii) Eugon LT 100 broth.

In a second aspect, the present invention provides a method of producing a composition for stain removal in accordance with the first aspect of the invention, the method comprising combining the at least one probiotic, bleach, and the enrichment medium into a liquid formulation.

In a third aspect, the present invention provides use of an enrichment medium to stabilize a composition for stain removal, the composition comprising at least one probiotic, bleach and the enrichment medium.

In a further aspect, the present invention provides use of a composition in accordance with the first aspect of the invention for stain removal.

### DETAILED DESCRIPTION

### A. Composition for Stain Removal

The present invention relates to compositions for use in stain removal. The present invention is particularly concerned with compositions for use in liquid-based stain removal. These compositions may be used for removing stains from a variety of different surfaces and/or fabrics including but not limited to textiles, carpets, laminate, stainless steel, marble, ceramic, glass and wood.

The present compositions may be used as multipurpose cleaners, floor cleaners, carpet cleaners, drain treatments, wastewater treatments, septic tank treatments, car cleaner or dish washing machine cleaner or malodour neutralizers. The present compositions may be used as laundry cleaners, for example for use in a washing machine. The present compositions may alternatively or in addition be used prior to laundering as a pre-treatment in soaking conditions. The present compositions may be used in a dishwasher. The present compositions may be applied directly to a stain.

The compositions in accordance with the present invention comprise at least three components: (i) at least one probiotic; (ii) bleach; and (iii) an enrichment medium. Each of these three components, including exemplary embodiments thereof, is described in more detail below. It will be understood that embodiments described below for each of the three components, particularly preferred embodiments, may be combined in any combination in the compositions of the present invention.

Unless otherwise specified, all percentages are to be considered percentages by weight.

a. Enrichment Media

The enrichment medium is present in the composition to assist in maintaining the viability of the probiotic or probiotics. The enrichment medium thus contains the ingredient or ingredients required to preserve the probiotics such that the microbial enzymes provided by the probiotics are available for stain removal.

In certain embodiments, the enrichment medium is capable of supporting the growth of the at least one probiotic present in the composition. For embodiments wherein the composition comprises more than one probiotic, the enrichment medium may support the growth and/or maintain the viability of one or more of the probiotics present in the composition. In certain embodiments wherein the composition comprises more than one probiotic, more than one enrichment medium may be included in the composition to support the growth and/or maintenance of the different probiotics present in the composition.

As stated above, the main purpose of the enrichment medium is to maintain the viability and/or support the growth of the probiotic or probiotics. Enrichment media capable of promoting the growth of microorganisms are known in the art and exemplary enrichment media are shown below in Table 1. Any of these enrichment media may be incorporated into the compositions of the present invention. The term “enrichment media” is typically used to differentiate growth-promoting media from other types of bacterial culture media including “selective media” and “differential media”. An enrichment medium is often a liquid medium which promotes the growth of a wide variety of microorganism or which promotes the growth of a specific bacterial species. Standard enrichment media rarely contain inhibitory substances to prevent the growth of any undesirable micro-organisms. In contrast, a selective medium is used for the growth of specific bacterial species but may include antibiotics, or lack certain amino acids, to prevent the growth of other bacterial species. Differential media contain compounds that allow groups of microorganisms to be visually distinguished by the appearance of the colony or the surrounding media, usually on the basis of some biochemical difference between the two groups. As used herein, the term “enrichment medium” refers to a medium capable of maintaining the viability of the probiotics present in the composition. It may be selected from any suitable enrichment medium available to those skilled in the art. The inclusion of one or more components typically found in selective media or differential media is not necessarily precluded in the enrichment medium used in the compositions, provided that these one or more components do not interfere with the ability of the enrichment medium to maintain the viability of the probiotics.

The enrichment medium used in the compositions of the invention may contain one or more, two or more, three or more, four or more essential components or ingredients. For embodiments wherein the enrichment medium includes multiple ingredients, the different ingredients or components may provide different functions.

In certain embodiments, the medium comprises one or more essential nutrients. The essential nutrients may include but are not limited to proteins, peptides and amino acids. Alternatively or in addition, the medium may comprise an energy source, for example a carbohydrate, for example glucose. Alternatively or in addition, the medium may comprise essential metals and minerals, such as calcium, magnesium, iron etc. Alternatively or in addition, the medium may comprise one or more buffering agents, such as phosphates and acetates. Alternatively or in addition, the medium may comprise one or more selective agents, such as antibiotics or chemicals. In preferred embodiments, the enrichment medium is a liquid or a liquid broth.

In certain embodiments, the enrichment medium comprises at least one ingredient selected from the group consisting of: tryptone; soy peptone; polysorbate 80; dextrose; sodium chloride; lecithin; Triton-X-100; L-cysteine HCl; sodium sulphite; casein peptone; sodium thioglycolate; yeast extract; meat extract; dipotassium hydrogen phosphate; glucose; sucrose; or any combination thereof.

In certain embodiments, the enrichment medium comprises at least one ingredient selected from the group consisting of: tryptone; soy peptone; polysorbate 80; dextrose; sodium chloride; lecithin; Triton-C-100; L-Cysteine HCl; and sodium sulphite. In certain embodiments, the enrichment medium comprises at least two, at least three, at least four, at least five ingredients selected from the group consisting of: tryptone; soy peptone; polysorbate 80; dextrose; sodium chloride; lecithin; Triton-C-100; L-Cysteine HCl; and sodium sulphite.

In certain embodiments, the enrichment medium comprises at least one ingredient selected from the group consisting of: peptone; meat extract; yeast extract; D(+)-glucose; dipotassium hydrogen phosphate; sodium acetate trihydrate; triammonium citrate; magnesium sulfate heptahydrate; manganous sulfate tetrahydrate. In certain embodiments, the enrichment medium comprises at least two, at least three, at least four, at least five ingredients selected from the group consisting of: peptone; meat extract; yeast extract; D(+)-glucose; dipotassium hydrogen phosphate; sodium acetate trihydrate; triammonium citrate; magnesium sulfate heptahydrate; manganous sulfate tetrahydrate.

It is to be understood that the enrichment medium may comprise any combination of components necessary to maintain the viability of the probiotic or probiotics in the composition. In certain embodiments, the enrichment medium is selected from the group consisting of: a chemically-defined medium; Eugon LT 100; MRS broth; nutrient broth; peptone water; tryptic soy broth; thioglycolate broth; soybean casein digest broth; lysogeny broth; and sporulation broth. Table 1 provides an exemplary and non-exhaustive list of enrichment media suitable for use in the present invention. The enrichment medium may comprise any one of the ingredients listed in Table 1, or any combination thereof.

TABLE 1
Enrichment Media

| Enrichment Medium | Ingredients |
|---|---|
| Eugon LT 100 broth | 15 g/l tryptone, |
| | 5 g/l soy peptone, |
| | 5 g/l polysorbate 80, |
| | 5.5 g/l dextrose, |
| | 4 g/l sodium chloride, |
| | 1 g/l lecithin, |
| | 1 g/l Triton-X-100, |
| | 0.7 g/l L-Cysteine HCL, |
| | 0.2 g/l sodium sulphite |
| MRS broth | 10 g/l peptone |
| | 8 g/l meat extract |
| | 4 g/l yeast extract |
| | 20 g/l D(+)-glucose |
| | 2 g/l dipotassium hydrogen phosphate |
| | 5 g/l sodium acetate trihydrate |
| | 2 g/l triammonium citrate |
| | 0.2 g/l magnesium sulfate heptahydrate |
| | 0.05 g/l manganous sulfate tetrahydrate |
| Nutrient broth | 15 g/l peptone |
| | 3 g/l yeast extract |
| | 6 g/l sodium chloride |
| | 1 g/l D(+)-glucose |
| Peptone water | 10 g/l peptone |
| | 5 g/l sodium chloride |
| Tryptic soy broth | 17 g/l casein peptone |
| (also known as CASO broth; | 3 g/l soy peptone |
| Soybean casein digest broth; | 5 g/l sodium chloride |
| and casein soy broth) | 2.5 g/l dipotassium hydrogen phosphate |
| | 2.5 g/l glucose |
| Thioglycolate broth | 15 g/l pancreatic digest of casein |
| (also known as USP Alternative | 5 g/l yeast extract |
| Medium; Fluid thioglycolate | 5.5 g/l dextrose |
| medium; and NIH thioglycolate | 2.5 g/l sodium chloride |
| broth) | 0.5 g/l L-Cysteine |
| | 0.5 g/l sodium thioglycolate |
| Lysogeny broth | 10 g/l peptone |
| | 5 g/l yeast extract |
| | 5 g/l sodium chloride |
| Sporulation broth | 6 g/l peptic digest of animal tissue |
| | 4 g/l casein enzymic hydrolysate |
| | 3 g/l yeast extract |
| | 1.5 g/l beef extract |
| | 1 g/l dextrose |
| | 0.3 g/l manganous sulfate |

In specific embodiments, the enrichment medium comprises 15 g/l tryptone and/or 5 g/l soy peptone and/or 5 g/l polysorbate 80 and/or 5.5 g/l dextrose and/or 4 g/l sodium chloride and/or 1 g/I lecithin and/or 1 g/l Triton-X-100 and/or 0.7 g/l L-Cysteine HCL and/or 0.2 g/l sodium sulphite. In specific embodiments, the enrichment medium comprises 15 g/l tryptone, 5 g/l soy peptone, 5 g/I polysorbate 80, 5.5 g/l dextrose, 4 g/l sodium chloride, 1 g/l lecithin, 1 g/l Triton-X-100, 0.7 g/l L-Cysteine HCL and 0.2 g/l sodium sulphite. In preferred embodiments, the enrichment medium is Eugon LT 100.

The enrichment medium must be present in the composition in sufficient quantity to maintain the viability of the at least one probiotic. The enrichment medium may represent at least 1 wt %, at least 2 wt %, at least 3 wt %, at least 4 wt %, at least 5 wt %, at least 10 wt %, at least 15 wt %, at least 20 wt %, at least 25 wt %, at least 30 wt % of the composition. In certain embodiments, the enrichment medium represents between about 5 wt % and about 15 wt % of the composition. In preferred embodiments, the enrichment medium is present at about 10 wt % of the composition. It is to be understood that the quantity of enrichment medium present in the composition may vary depending upon the relative quantity of probiotic and/or the relative quantity of bleach present in the composition. For instance, if the concentration of bleach is increased, it may also be necessary to increase the quantity of enrichment medium. If the quantity of probiotic is increased, it may also be necessary to increase the quantity of enrichment medium.

b. Probiotic

The compositions of the invention comprise at least one probiotic. In certain embodiments, the compositions comprise two or more, three or more, four or more probiotics. The probiotic or probiotics are provided in the compositions primarily as a source of enzymes to digest and degrade soils such as grease, oil, fat, protein, and/or carbohydrate. The enzymes work in conjunction with the bleach in the composition to tackle the components of complex stains.

The probiotics used in the compositions of the invention are preferably bacterial species producing enzymes capable of stain removal. It can be preferable to provide digestive enzymes via bacterial probiotics in the context of cleaning compositions for the reason that this can produce a longer-lasting effect. The enzymes can break down soils so as to produce an energy source. This energy source can then be used by the bacteria to fuel further growth. The continued growth of bacteria serves as a continual source of enzymes. This can be beneficial as compared with products in which the enzymes are provided in free form because in such compositions, the enzymes may become inactive over time. In contrast, compositions comprising bacteria can continue to produce enzymes over time which ensures the continued breakdown of soils after application.

The present compositions may comprise any bacterial species containing enzymes capable of digesting, degrading, or promoting the degradation of lipids, proteins, carbohydrates, or other organic matter, common to domestic and industrial soils. Such enzymes include but are not limited to proteases, amylases, lipases, cellulases. Many suitable species and strains of bacteria will be known to those skilled in the art and are available via commercial suppliers.

In preferred embodiments, the at least one probiotic is a spore-forming bacteria or spore blend. In certain embodiments, the at least one probiotic is an aerobic bacteria or a facultative anaerobic bacteria. In certain preferred embodiments, the at least one probiotic is a bacterial species of the Bacillus genus. In specific embodiments, the bacterial species is selected from Bacillus megaterium, Bacillus amyloliquefaciens, Bacillus subtilis, Bacillus pumilus, Bacillus brevis, Bacillus sphaericus, Bacillus coagulans, Bacillus circulans, and Bacillus licheniformis. For embodiments wherein the probiotic is a Bacillus bacterium, it is preferred that the Bacillus species or strain is non-pathogenic. The at least one probiotic may be any bacterial species of the Bacillus genus provided that the bacterium is capable of digesting or degrading a soil, and is itself non-pathogenic. Examples of pathogenic bacteria not suitable for use in the present invention include Bacillus anthracis, Bacillus cereus, or any other pathogenic or opportunistic pathogen. Suitable bacterial spores are commercially available from a variety of suppliers and include Drain Ease™ Open spores (Novozymes), and Bacilox® (Osprey Biotechnics, Inc.), and UB1 Kultur and UB2 Kultur (Julius Hoesch GmbH & Co. KG).

The probiotics used in the compositions of the invention may be naturally-occurring bacterial species. Alternatively, the bacterial species or strain may have been engineered or adapted so as to achieve high level of production of enzymes beneficial for stain removal. Such enzymes include but are not limited to: proteases, amylases, lipases, and cellulases.

The concentration or quantity of probiotics in the compositions of the invention may vary. For example, a higher concentration of probiotic may be required in a composition containing a higher quantity of bleach. For embodiments in which the probiotic is provided in the form of spore-forming bacteria, a higher concentration of probiotic may be required as compared to embodiments wherein the probiotic is provided as live bacteria.

In certain embodiments wherein the probiotic is provided in the form of spore-forming bacteria, the concentration of probiotic spores in the composition is from about 1×10³ to about 1×10⁹ CFU/ml, from about 1×10⁴ to about 1×10⁸ CFU/ml, from about 1×10⁵ to about 1×10⁷ CFU/ml, preferably about 1×10⁷ CFU/ml. Alternatively, or in addition, the probiotic spores may represent at least 0.01 wt %, at least 0.02 wt %, at least 0.03 wt, % at least 0.04 wt %, at least 0.05 t %, at least 1 wt %, at least 2 wt %, at least 3 wt %, at least 4 wt %, at least 5 wt %, at least 10 wt %, at least 15 wt %, at least 20 wt %, or at least 25 wt % of the composition.

Advantageously, the probiotics, for example the probiotic spores, in the compositions of the invention remain stable despite being present in an oxidising environment with bleach. The probiotics, for example the probiotic spores, typically remain stable at room temperature and/or at ambient temperature. In certain embodiments, the probiotics, preferably the probiotic spores, are stable in the composition at temperatures between about 15° C. and about 30° C., or between about 20° and about 25° C. In certain embodiments, the probiotics, preferably the probiotic spores, are stable in the composition at room temperature for at least 1 month, at least 2 months, at least 3 months, at least 4 months, at least 6 months, or at least 12 months. In certain embodiments, the probiotics, preferably the probiotic spores, are stable in the composition at ambient temperature for at least 1 month, at least 2 months, at least 3 months, at least 4 months, at least 6 months, or at least 12 months.

The term “stable” as used herein is intended to mean that the viability of the probiotics is maintained such that they can continue to provide a source of enzymes for the composition. For probiotics provided in the form of live bacteria, the probiotic may be regarded as stable if the bacteria retain the ability to grow in the composition, notwithstanding the presence of bleach. The probiotic may also be regarded as “stable” if the replicative potential is reduced by no more than 20%, no more than 15%, no more than 10%, or no more than 5% in the bleach-containing composition.

For probiotics provided in the form of spores, the spores may be regarded as stable if the spores remain in a dormant state but are capable of being reactivated under appropriate conditions, i.e. the spores are capable of germinating in the presence of a food source. For spore-forming probiotics, the probiotic may be regarded as stable if a significant concentration of spores (as measured by colony forming units) remain in the composition after a defined period of time. For example, the probiotic spores may be regarded as stable if the concentration (as measured by cfu) decreases by less than 20%, less than 15%, less than 10%, less than 5%, or less than 1% over the shelf life of the product. In certain embodiments, the concentration of probiotic spores in the composition decreases by less than 20%, less than 15%, less than 10%, less than 5%, or less than 1% over a period of at least 1 month, at least 2 months, at least 3 months, at least 4 months, at least 6 months, or at least 12 months. Alternatively, or in addition, the concentration of spore-forming bacteria in the composition decreases by less than 20%, less than 15%, less than 10%, less than 5%, or less than 1% over a period of at least 1 month, at least 2 months, at least 3 months, at least 4 months, at least 6 months, or at least 12 months.

As explained elsewhere herein, the enrichment medium assists in maintaining the viability i.e. stabilizing the at least one probiotic present in the composition. Therefore, the specific enrichment medium used in the composition may be dependent upon the specific probiotic or probiotics used in the composition. The enrichment medium may be selected specifically to stabilize the particular probiotic or probiotics included in the composition. For example, if the probiotic is selected from an aerobic bacterial species, the enrichment medium may be selected to stabilize the selected aerobic bacterial species. If the probiotic is selected from an anaerobic bacterial species, the enrichment medium may be selected to stabilize the selected anaerobic bacterial species.

For embodiments wherein the at least one probiotic is a species from the Bacillus genus, the enrichment medium may be selected so as maintains the viability and/or stabilize the selected Bacillus species. The skilled person will be aware of suitable enrichment media to enrich for and stabilize specific bacterial species. For instance, tryptic soy broth is known to support the growth of Bacillus subtilis.

c. Bleach

The bleach used in the composition of the invention may be any bleach component or material suitable to confer bleaching activity on the composition. Bleach components are materials suitable for use in stain removal compositions are known to those skilled in the art. The bleach for use in the compositions described herein may be an oxygen-based bleach, a chorine-based bleach, a sulphur-dioxide based bleach, or combinations thereof. Preferably, the bleach is an oxygen-based bleach or a peroxide-based bleach. Inorganic peroxides include percarbonates, perborates, persulphates, hydrogen peroxide and derivatives and salts thereof. In preferred embodiments, the bleach is hydrogen peroxide.

In certain embodiments, the bleach is present in an amount from about 0.001 wt % to about 16 wt %, from about 0.01 wt % to about 10 wt %, from about 0.05 wt % to about 8 wt %, from about 0.1 wt % to about 6 wt %, from about 1 wt % to about 5 wt %, or from about 2 wt % to about 4 wt % of the composition.

Particularly preferred embodiments of the compositions described herein are set forth below.
In preferred embodiments, the composition comprises:
(i) at least one probiotic selected from Bacillus megaterium, Bacillus amyloliquefaciens, Bacillus subtilis, and Bacillus pumilus;
(ii) a peroxide-based bleach; and
(iii) at least one ingredient selected from the group consisting of: tryptone; soy peptone; polysorbate 80; dextrose; sodium chloride; lecithin; Triton-C-100; L-Cysteine HCl; and sodium sulphite.
In preferred embodiments, the composition comprises:
(i) at least one probiotic selected from Bacillus megaterium, Bacillus amyloliquefaciens, Bacillus subtilis, and Bacillus pumilus;
(ii) hydrogen peroxide bleach; and
(iii) Eugon LT 100 broth.
In preferred embodiments, the composition comprises:
(i) Bacillus subtilis;
(ii) hydrogen peroxide bleach; and
(iii) Eugon LT 100 broth.
In preferred embodiments, the composition comprises:
(i) at least one probiotic selected from Bacillus megaterium, Bacillus amyloliquefaciens, Bacillus subtilis, and Bacillus pumilus, wherein the concentration of probiotic spores in the composition is from about 1×10³ to about 1×10⁹ CFU/ml;
(ii) hydrogen peroxide bleach; and
(iii) Eugon LT 100 broth.

d. Additional Ingredients

The compositions of the invention are preferably provided as liquids. The compositions may be provided in the form of a concentrate, and may be diluted with water prior to use. The composition may comprise a solvent. In a preferred embodiment, the solvent is water. The composition may be formulated so as to be suitable for incorporation into other cleaning compositions.

The compositions of the invention may optionally include one or more further ingredients in addition to the probiotic, bleach and enrichment medium. The additional ingredients included in the compositions of the invention may reflect the intended use of the composition for stain removal. For example, if the composition is intended as a laundry stain removal composition, the composition may comprise one or more conventional agents typically used in laundry stain removal compositions. Such agents include but are not limited to surfactants, fragrances, optical brighteners, dye transfer inhibitors, odour absorbers, anti-static agents, thickeners (for example, hydroxyethylcellulose and/or xanthan gum), anti-foaming agents. Further additives suitable for inclusion in the compositions described herein, include but are not limited to viscosity modification agents; water softening agents; preservatives; stabilizing agents; chelating agents; organic solvents; and colouring agents. Such optional constituents should be selected so as to have little or no detrimental effect upon the activity of the at least one probiotic present in the composition. Such optional constituents are well known to those skilled in the art. In certain embodiments, the composition further comprises a surfactant, a chelating agent, and/or a preservative. Suitable surfactants are known to those skilled in the art, and include non-ionic surfactants, anionic surfactants, cationic surfactants, amphoteric surfactants, zwitterion surfactants, and combinations thereof. The surfactants used should cause minimal harm to the at least one probiotic present in the composition.

### B. Methods and Uses

In a second aspect, the present invention provides a method of producing a composition for stain removal in accordance with the first aspect of the invention, the method comprising combining the at least one probiotic, bleach, and the enrichment medium. The three ingredients may be combined, preferably into a liquid formulation, using any technique or techniques known in the art. The three ingredients may be combined into a concentrate which can be diluted prior to use. The compositions of the present invention may be produced by any process known in the art for the production of stain removal compositions, including but not limited to batch processing, continuous loop processing, or combinations thereof. The compositions may be prepared by combining the components in any convenient order.

The individual ingredients of the compositions may be formulated prior to combining the ingredients in the compositions of the invention. For example, the bleach may be provided as a concentrate requiring dilution prior to inclusion in the composition. Alternatively or in addition, the bleach may be provided as a pre-formulated product suitable for combining with the probiotic and enrichment medium. Pre-formulated bleach products that may be suitable for producing compositions in accordance with the invention include Vanish®, a known bleaching product that contains diluted hydrogen peroxide. The pre-formulated bleach product may contain one or more additional ingredients in addition to the bleach, including one or more of the additional ingredients mentioned in section d. above. Vanish® liquid, which may be used as a source of bleach in the compositions of the present invention, may comprise 93.31% water, 0.33% xantham gum, 0.14% sodium hydroxide, 1.06% sulphonic acid, 0.9% lauryl alcohol, 0.18% HEDP-phosphonate, 0.07% fragrance, 0.01% antifoam, and 4% hydrogen peroxide. For embodiments wherein the bleach is provided as a pre-formulated product, the product may be added to the probiotic and enrichment medium such that the final concentration of bleach, for example hydrogen peroxide, is from about 0.001 wt % to about 16 wt %, from about 0.01 wt % to about 10 wt %, from about 0.05 wt % to about 8 wt %, from about 0.1 wt % to about 6 wt %, from about 1 wt % to about 5 wt %, or from about 2 wt % to about 4 wt % of the composition.

In a third aspect, the present invention provides use of an enrichment medium to stabilize a composition for stain removal, the composition comprising at least one probiotic, bleach and the enrichment medium. All embodiments described above in connection with the first aspect of the invention are equally applicable to this third aspect of the invention.

In a further aspect, the present invention provides use of a composition in accordance with the first aspect of the invention for stain removal. The composition may be used in liquid-based stain removal. The composition may be used for removing stains from a variety of different surfaces and/or fabrics including but not limited to textiles, carpets, laminate, stainless steel, marble, ceramic, and wood. The composition may be used as a multipurpose cleaner, floor cleaner, carpet cleaner, drain treatment, wastewater treatment, septic tank treatment, or malodour neutralizer. The present compositions may be used as laundry cleaners, for example for use in a washing machine. The present compositions may alternatively or in addition be used prior to laundering as a pre-treatment in soaking conditions. The present compositions may be used in a dishwasher. The present compositions may be applied directly to a stain.

The invention will now be further understood with reference to the following non-limiting examples.

### EXAMPLES

### 1) Test of Bacterial Spores in Soaking Conditions in the Presence of Vanish® Liquid Product

### Simulated Soaking

Soaking was simulated on a small scale in bottles to represent consumer relevant conditions. Cloths of technical stain CFT-CS-27 (Centre for Test materials) were used to simulate the soil (in this case, coloured potato starch on cotton), and were sterilized by UV irradiation. The tap water used was sterilized by autoclaving.
Each soaking condition contained 100 ml of water per bottle, a final concentration of Vanish® liquid product as per Table 2 below, and 10% of Eugon LT 100 broth (VWR International) or MRS broth (Sigma-Aldrich) as enrichment medium. The components of Eugon LT 100 broth and MRS broth are shown in Table 1 above. The composition of the Vanish® liquid product used is shown in Table 3 below.
1 ml of Drain Ease™ Open 20X spores (Novozymes) which contains the bacterial spores Bacillus megaterium, Bacillus amyloliquefaciens, Bacillus subtilis, and Bacillus pumilus, was added in all bottles together with 2 cloths of 36 cm² of CFT-CS-027.

### Bacterial Spores Quantification

The spores were quantified by standard plate count, using serial dilutions in Letheen Broth (Sigma-Aldrich) and plated on Tryptic Soy Agar (Sigma-Aldrich) as growth medium for 5 days at 32° C. in aerobic conditions. The results of the Total Viable Aerobic Count are expressed in logarithmic scale as CFU (colony forming units) per ml of soaking water. The spores were quantified at the start (0 hours) and at end of the soaking (5 hours), as reported in Table 2.

### Data Analysis

Total Viable Aerobic Count for each soaking condition represents the average of two independent replicates.
When no enrichment medium was included (see soaking conditions 7, 8, and 9), a significant reduction in Total Viable Aerobic Count was observed even before soaking had taken place. In contrast, when Eugon LT 100 broth was included as an enrichment medium, the results showed that there is no significant reduction in Total Viable Aerobic Count after 5 hours of soaking in the presence of 0% or 0.05% of Vanish®. When soaking in the presence of 0.5% Vanish®, a significant reduction in the level of detectable viable bacteria after 5 hours was observed, although this was a reduction of less than 3%. These results show the stabilizing properties of the enrichment medium, particularly at high doses of Vanish® concentration, to recover the Total Viable Aerobic Count of the probiotic spores when in the presence of bleach.

TABLE 2

| | | | | | 0 h | 5 h |
|---|---|---|---|---|---|---|
| | Technical | Vanish | Enrichment | Inoculum | soaking | soaking |
| Soaking | stain | concentration | Medium 10% | Log(CFU/ml) | Log(CFU/ml) | Log(CFU/ml) |
| 1 | CS-27 | 0.50% | Eugon LT 100 | 7.38 | 7.04 | 6.81 |
| 2 | CS-27 | 0.05% | Eugon LT 100 | 7.38 | 7.09 | 7.20 |
| 3 | CS-27 | 0% | Eugon LT 100 | 7.38 | 7.12 | 7.02 |
| 4 | CS-27 | 0.50% | MRS broth | 7.38 | 7.26 | <6 |
| 5 | CS-27 | 0.05% | MRS broth | 7.38 | 7.26 | 6.8 |
| 6 | CS-27 | 0% | MRS broth | 7.38 | 7.08 | 6.7 |
| 7 | CS-27 | 0.50% | None | 7.38 | <6 | <6 |
| 8 | CS-27 | 0.05% | None | 7.38 | <6 | <6 |
| 9 | CS-27 | 0% | None | 7.38 | <6 | <6 |

TABLE 3
Vanish Formulation

| Material | wt % |
|---|---|
| DEIONISED WATER | 93.31 |
| Detergent agents | 2.28 |
| Hydrogen peroxide (100%) | 4.00 |
| Fragrance, dyes and thickeners | 0.41 |
| Probiotics | 0.00 |
| | 100.00 |

The present invention is not to be limited in scope by the specific embodiments described herein. Indeed, various modifications of the invention in addition to those described herein will become apparent to those skilled in the art from the foregoing description and accompanying figures. Such modifications are intended to fall within the scope of the appended claims. Moreover, all aspects and embodiments of the invention described herein are considered to be broadly applicable and combinable with any and all other consistent embodiments, including those taken from other aspects of the invention (including in isolation) as appropriate.

Various publications and patent applications are cited herein, the disclosures of which are incorporated by reference in their entireties.

1. A composition for use in stain removal comprising:
at least one probiotic;
a bleach; and
an enrichment medium.

2. The composition of claim 1, wherein the enrichment medium comprises any one of tryptone, soy peptone, polysorbate 80, dextrose, sodium chloride, lecithin, Triton-X-100, L-cysteine HCl, sodium sulphite, casein peptone, sodium thioglycolate, yeast extract, meat extract, dipotassium hydrogen phosphate, glucose, sucrose, or any combination thereof.

3. The composition of claim 1, wherein the enrichment medium is selected from the group consisting of a chemically-defined medium, Eugon LT 100 broth, MRS broth, nutrient broth, peptone water, tryptic soy broth, thioglycolate broth, soybean casein digest broth, lysogeny broth, and sporulation broth.

4. The composition of claim 3, wherein the enrichment medium comprises 15 g/l tryptone, 5 g/l soy peptone, 5 g/l polysorbate 80, 5.5 g/l dextrose, 4 g/l sodium chloride, 1 g/l lecithin, 1 g/l Triton-X-100, 0.7 g/l L-Cysteine HCL, and 0.2 g/l sodium sulphite.

5. The composition of claim 3, wherein the enrichment medium is Eugon LT 100 broth.

6. The composition of claim 1, wherein the enrichment medium is between about 5 wt % and about 15 wt % of the composition.

7. The composition of claim 1, wherein the at least one probiotic is a spore-forming bacteria or a spore blend.

8. The composition of claim 7, wherein the concentration of probiotic spores in the composition is from about 1×10³ to about 1×10⁹ CFU/ml.

9. The composition of claim 7, wherein the probiotic spores in the composition are stable at room temperature for at least 1 month.

10. The composition of claim 7, wherein the at least one probiotic is a bacterial species of the Bacillus genus.

11. The composition of claim 10, wherein the bacterial species is selected from the group consisting of Bacillus megaterium, Bacillus amyloliquefaciens, Bacillus subtilis, and Bacillus pumilus.

12. The composition of claim 1, wherein the bleach is selected from the group consisting of an oxygen-based bleach, a chorine-based bleach, a sulphur-dioxide based bleach, and combinations thereof.

13. The composition of claim 12, wherein the bleach is an oxygen-based bleach.

14. The composition of claim 1, wherein the bleach is present in an amount from about 0.001 wt % to about 16 wt % of the composition.

15. The composition of claim 1, wherein the composition is a liquid.

16. The composition of claim 1, wherein the composition further comprises one or more ingredients selected from the group consisting of: a surfactant, a fragrance, an optical brightener, a dye transfer inhibitor, an odour absorber, an anti-static agent, a thickener, an anti-foaming agent, a viscosity modification agent, a water softening agent, a preservative, a chelating agent, a colouring agent, and combinations thereof.

17. The composition of claim 1, comprising
at least one probiotic selected from the group consisting of Bacillus megaterium, Bacillus amyloliquefaciens, Bacillus subtilis, and Bacillus pumilus, and combinations thereof;
hydrogen peroxide bleach; and
Eugon LT 100 broth.

18. A method of producing a composition for use in stain removal according to claim 1, the method comprising:
combining the at least one probiotic, bleach, and the enrichment medium into a liquid formulation.

19. A method of using an enrichment medium to stabilize a composition for stain removal, the composition comprising at least one probiotic, bleach, and the enrichment medium.

20. A method of using a composition according to claim 1 for stain removal.
